(19) United States
(12) Patent Application Publication
(10) Pub. No.: US 2002/0129688 A1
(43) Pub. Date: Sep. 19, 2002

(54) Precision electric miter box

(76) Inventor: James G. Watson, Perry Hall, MD (US)

Correspondence Address: LEONARD BLOOM & ASSOCIATES, LLC, Intellectual Property Law Offices, Suite 905, 401 Washington Avenue, Towson, MD, 21204, US

(21) Appl. No.: 09/918,948

(22) Filed: Jul. 31, 2001

Related U.S. Application Data
(63) Continuation-in-part of application No. 09/808,686, filed on Mar. 15, 2001.

(51) Int. Cl. B26D 3/02

(52) U.S. Cl. 83/100; 83/581

(57) ABSTRACT

A miter box has a housing with support within the housing for supporting a motor. The motor drives a cutter. The motor is pivotably disposed with respect to a vertical plane through the housing and is disposed at a desired angular relationship. The motor may be manually moved by the support. A fence is pivotally mounted on the top of housing at a selected angle to correspond with a desired miter cut. A workpiece is held against the fence on the top of the housing at a selected angular relationship to the cutting means. The workpiece may be miter cut and bevel cut simultaneously. The device may also be used as a scroll saw.

### CROSS REFERENCE TO RELATED APPLICATIONS

The present application is a continuation-in-part of application Ser. No. 09/808,686 filed Mar. 15, 2001, the disclosure of which is incorporated in its entirety by reference herein.

### BACKGROUND OF THE INVENTION

1. Field of the Invention

The present invention relates to miter boxes and more specifically to a precision miter box with a cutting means powered by an electric motor.

2. Description of Related Art

Miter boxes have been used for many years to reproducibly cut a workpiece at a desired angle. The conventional miter box is a channel-shaped device having diagonal slits in the side walls at angles such as 30° and 45° whereby a saw is placed in the diagonal slits for the desired angle and the saw is guided in cutting the workpiece which is disposed within the channel.

A conventional miter box which additionally has a pivotal bed for cutting compound angles is disclosed by Schramm, II in U.S. Pat. No. 4,461,196. A compound miter box provided with saw guides pivotable about a vertical and horizontal axis used with a hand-operated saw is disclosed by Keddie in U.S. Pat. No. 5,713,258. In U.S. Pat. No. 5,819,619, Miller et al disclose a dust or chip collection system for a compound miter saw which has a powered saw blade. Colberg et al in U.S. Pat. No. 4,270,427 disclose a tool elevation and bevel adjustment mechanism for a direct drive power tool such as a table saw wherein the tool's drive motor is mounted on a plate which is pivotally suspended below the work table of the power tool. The tool is mounted on the rotor shaft of the motor. The plate with the motor mounted thereon is selectively pivotal with respect to the table. The motor is pivotally mounted on the plate for arcuate movement with respect to the plate utilizing an elevation adjustment screw linkage. In U.S. Pat. No. 4,807,506, Audet discloses a saw table having an undercarriage mounted under the table pivotable about an axis adjacent one of its lateral sides and angularly actuated by a handle extending on the side of the table opposite the axle. Sherveglieri, in U.S. Pat. Nos. 5,720,213 and 5,943,932 discloses a bevel table saw comprising a table having a slot for the saw blade. The saw blade can be angled to make beveled cuts in a workpiece mounted on the table. Automatic adjustment of the depth of cut of the saw blade is provided when the saw blade is beveled.

There remains a need for a power driven cutting means which can make precision, reproducible miter cuts and bevel cuts on a workpiece.

### BRIEF SUMMARY OF THE INVENTION

It is an object of the invention to provide a precision miter box which has a powered cutting means to make miter and bevel cuts on the workpiece.

It is a further object of the present invention to provide a miter box in which the cutting means is moved with respect to the workpiece and the cutting means can be placed at a selected angle with respect to the workpiece.

It is still another object of the present invention to provide a miter box having a protective guard over the cutting means.

It is yet another object of the present invention to provide a miter box to which is optionally connected a source of vacuum to remove debris from cutting.

It is an additional object of the present invention to provide an apparatus which can be used as a miter box and a scroll saw.

In accordance with the teachings of the present invention, there is disclosed a miter box having a housing having a top. An elongated opening is formed in the top. A cutting means is slidably received within the housing and disposed within the elongated opening. At least one curved track is formed on the top of the housing. A fence is pivotally mounted on the top of the housing. At least one protrusion extends downwardly from the fence. The at least one protrusion is received in the at least one curved track on the top of the housing. The fence has a working face perpendicular to the top of the housing. A means is provided for pivotally moving the fence, wherein the fence may be pivotally moved to a selected angle with respect to the elongated opening. A workpiece is disposed against the working face of the fence, the workpiece extending over the elongated opening such that sliding the cutting means in the elongated opening cuts the workpiece at an angle corresponding to the selected angle at which the fence is disposed.

In further accordance with the teachings of the present invention, there is disclosed in a miter box having a housing having a top, a cutting means slidably received in the housing and extending upwardly of the top, and at least one curved track formed in the top. The improved miter box has a fence pivotally mounted on the top of the housing at a selected angle. At least one protrusion extends downwardly from the fence. The at least one protrusion is received in the at least one curved track. The fence has a working face perpendicular to the top of the housing. When a workpiece is disposed against the working face of the fence, the workpiece is cut by the cutting means at the selected angle.

These and other objects of the present invention will become apparent from a reading of the following specification taken in conjunction with the enclosed drawings.

### BRIEF DESCRIPTION OF THE DRAWINGS

FIG. 1 is a perspective view of the miter box of the present invention.

FIG. 2 is a top plan view of the housing of the miter box with the work-holding member and the cover not shown.

FIG. 3 is an end view of the work-holding member.

FIG. 4 is a side elevation view of the work-holding member.

FIG. 5 is a top plan view of the work-holding member.

FIG. 6 is a top plan view of the miter box showing the work-holding member at 0° inclination with respect to the virtual transverse cutting axis contained in the elongated opening.

FIG. 7 is a top plan view showing the work-holding member at a −15° inclination with respect to the virtual transverse cutting axis contained in the elongated opening.

FIG. 8 is a top plan view of the miter box showing the work-holding member at a +45° inclination with respect to the virtual transverse cutting axis contained in the elongated opening.

FIG. 9 is a top plan view of the miter box showing the work-holding member at a −30° inclination with respect to the virtual transverse cutting axis contained in the elongated opening.

FIG. 10 is a bottom plan view of the miter box.

FIG. 11 is a side elevation view showing the motor and cutting means longitudinally movable on the support means and showing no rotation of the motor and cutting means.

FIG. 12 is a sectional view taken across the lines 12-12 of FIG. 11.

FIG. 13 is a side elevation view showing the motor and cutting means rotated 45° positively.

FIG. 14 is the end view of FIG. 13 showing the motor and cutting means in broken lines.

FIG. 15 is a sectional view taken across the lines 15-15 of FIG. 13.

FIG. 16 is the view of FIG. 11 having a circular saw blade connected to the motor.

FIG. 17 is the end view of FIG. 16 showing the motor and cutting means in broken lines.

FIG. 18 is the view of FIG. 13 having a circular saw blade connected to the motor.

FIG. 19 is the end view of FIG. 18 showing the motor and cutting means in broken lines.

FIG. 20 is a side elevation view of the frame for the protector.

FIG. 21 is a top view of the frame for the protector.

FIG. 22 is a perspective view of the protector with the cover.

FIG. 23 is a perspective view showing a vacuum line connected to the miter box.

FIG. 24 is a perspective view showing a long workpiece disposed in the workpiece holder on the miter box with the ends of the workpiece extending outwardly from opposite sides of the miter box.

FIG. 25 is a diagrammatic series of views showing the relationship of the workpiece to the cutting means angled at −45° at different angles of insertion of the workpiece.

FIG. 26 is the diagrammatic series of views of FIG. 25 when the cutting means is at 0°.

FIG. 27 is the diagrammatic series of views of FIG. 25 when the cutting means is at +45°.

FIG. 28 is a perspective view of a workpiece having adjoining bias cuts at different angles.

FIG. 29 is a perspective view of the present invention having a fence in place of a workholding member.

FIG. 30 is an enlarged cross-sectional view taken across the lines 30-30 of FIG. 29.

FIG. 31 is a cross-sectional view taken across the lines 31-31 of FIG. 30.

FIG. 32 is a partial cutaway perspective view showing a handle connected to the fence.

FIG. 33 is a perspective view showing another embodiment of a handle.

FIG. 34 is a partial cutaway side view of the handle in FIG. 33.

FIG. 35 is a top plan view of the present invention showing the pivotable fence.

FIG. 36 is an end view of the top of the housing showing the pivotable fence at the pivot point.

FIG. 37 is a bottom plan view of the fence at the pivot point.

FIG. 38 is a top plan view of the present invention showing the fence, the cutting means, and the virtual cutting axis of the cutting means.

FIG. 39 is a cross-section view taken across the lines 39-39 of FIG. 38 and illustrates the end rotations of the cutting means about the pivot point and the rotational axis of the fence.

FIG. 40 is a diagram showing the positions and relations of the virtual cutting axis and the fence rotation axis.

FIGS. 41-45 are a sequence showing the method of cutting a workpiece at a selected angle.

FIG. 46 is a perspective view of the operator using the present invention.

FIG. 47 is a perspective view showing manipulation of the workpiece in use of the present invention as a scroll saw.

### DESCRIPTION OF THE PREFERRED EMBODIMENTS

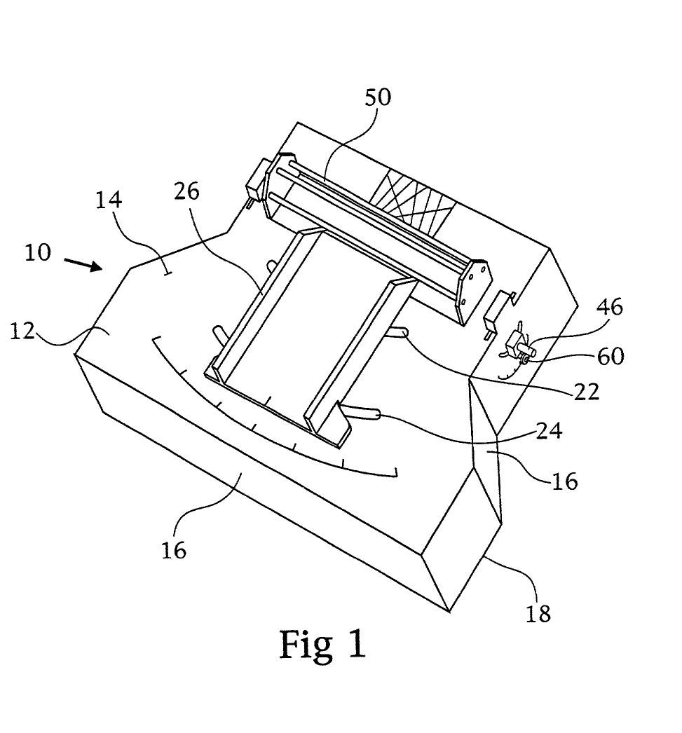

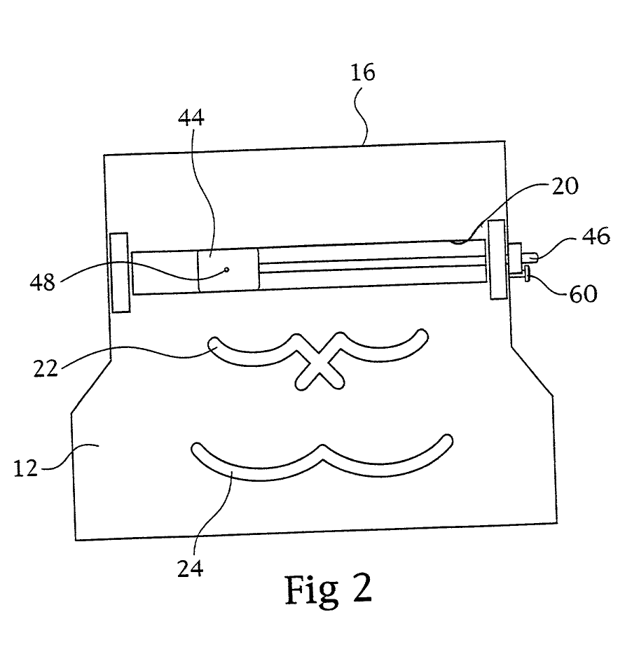

Referring now to FIGS. 1-2, the miter box 10 of the present invention has a housing 12 with a top surface 14 and a plurality of side walls 16. The housing may have four or more side walls 16 to elevate the top surface 14 above a table or other surface and to provide an enclosure 18 for components as will be described.

An elongated opening 20 is formed in the top surface 14 of the housing 12. The elongated opening 20 is near a first supporting wall 16 and extends transversely across the housing 12. A first curved track 22 is disposed in the top surface 14 proximal to the elongated opening 20. Preferably, the first curved track 22 has two portions shaped as inverted letter “L” with curved bases and legs. The leg portions intersect one another. A second curved track 24 is spaced apart from the first curved track 22 and is distal from the elongated opening 20. The second curved track 24 has a chevron shape. The first track 22 and the second track 24 may be a depression or cut out in the top surface 14 of the housing 12 or may be a raised channel mounted on, and extending above, the top surface of the housing 12.

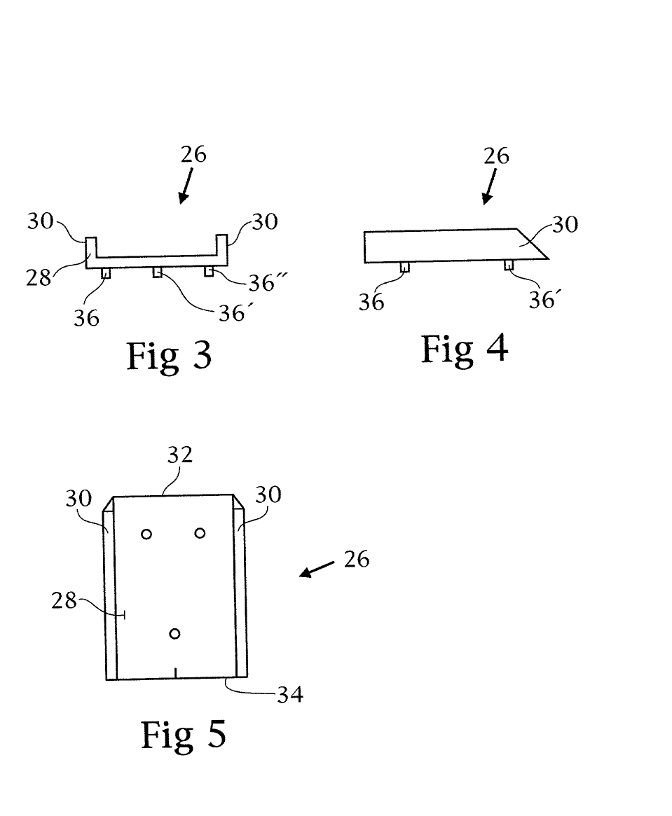

As shown in FIGS. 3-4, a work-holding member 26 has a channel shape with a base 28 and two opposite side walls 30 extending longitudinally on the base 28 between the first end 32 and the second end 34 of the work-holding member 26. The ends 32, 34 are open, having no walls formed thereon. In this manner a workpiece W may be disposed within the work-holding member 26 between the side walls 30 with the workpiece extending from the first end 32 or from both the first end 32 and the second end 34 as there is no restriction on the length of the workpiece W. The work-holding member 26 further has at least two protrusions 36 extending downwardly from the bottom surface of the base 28. The protrusions 30 may be a peg or pin. One protrusion 36, disposed proximal to the second end 34 of the work-holding member 26, is received in the second curved track 24 on the top surface 14 of the housing 12. At least one, and preferably two, protrusions 36 are disposed proximal to the first end 32 of the work-holding member 26. If there are two protrusions 36′, 36″, the protrusions are spaced apart. The protrusions 36′, 36″ are received in the first curved track 22. If there are two protrusions, one protrusion 36′ is received in one of the inverted “L” portions and the other protrusion 36″ is received in the other of the inverted “L” portions. In this manner, the work-holding member 26 is connected to the top surface 14 of the housing 12.

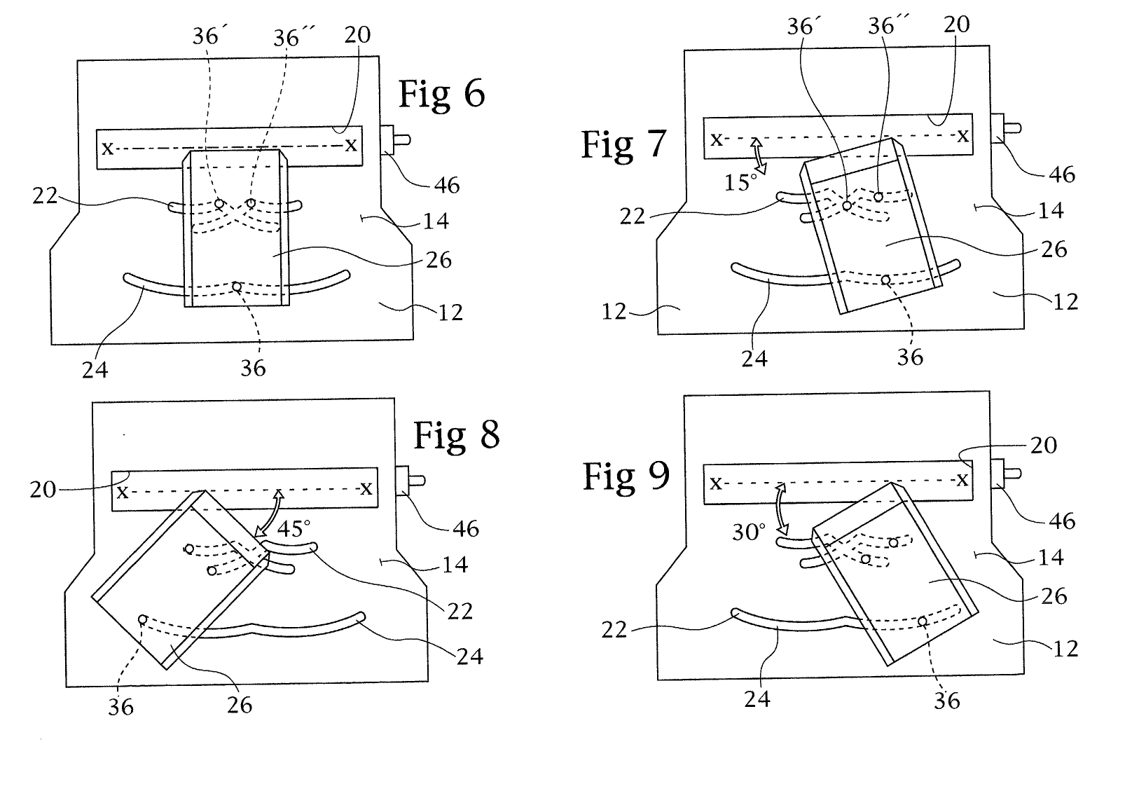

As shown in FIGS. 6-9, due to the configuration of the first curved track 22 and the second curved track 24, the work-holding member 26 may be slidably moved with respect to the top surface 14 of the housing 12. The protrusion 36 near the second end 34 guides the second end of the work-holding member 26 within the second curved track 24. The protrusion(s) near the first end 32, guide the first end of the work-holding member 26 within the first curved track 22. In this manner, the work-holding member 26 may be moved between 45° and −45° with respect to the virtual (phantom) transverse cutting axis XX contained in the elongated opening 20. In order to assure a selected angular disposition of the work-holding member 26, an index is placed on the base 26 of the work-holding member 26 and scalar indices are marked on the top surface 14 of the housing 12 such that the index on the base 26 of the work-holding member 26 may be juxtapositioned to the selected angle for cutting the workpiece W as will be described. When so aligned, the first end 22 of the work-holding means 26 is disposed at a corresponding angle with the virtual transverse cutting axis XX contained in the elongated opening 20.

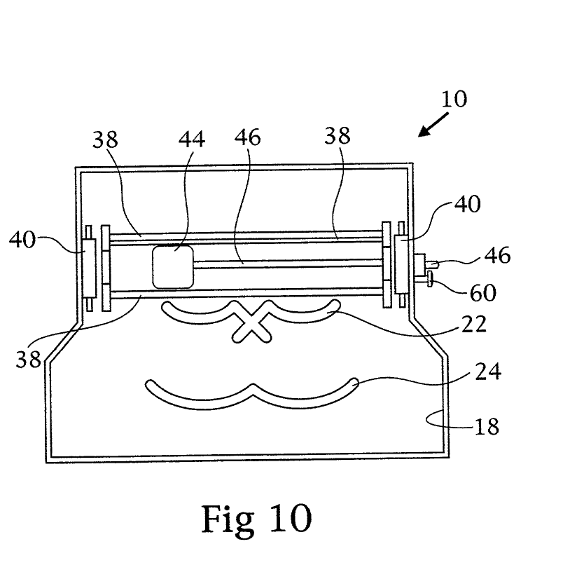

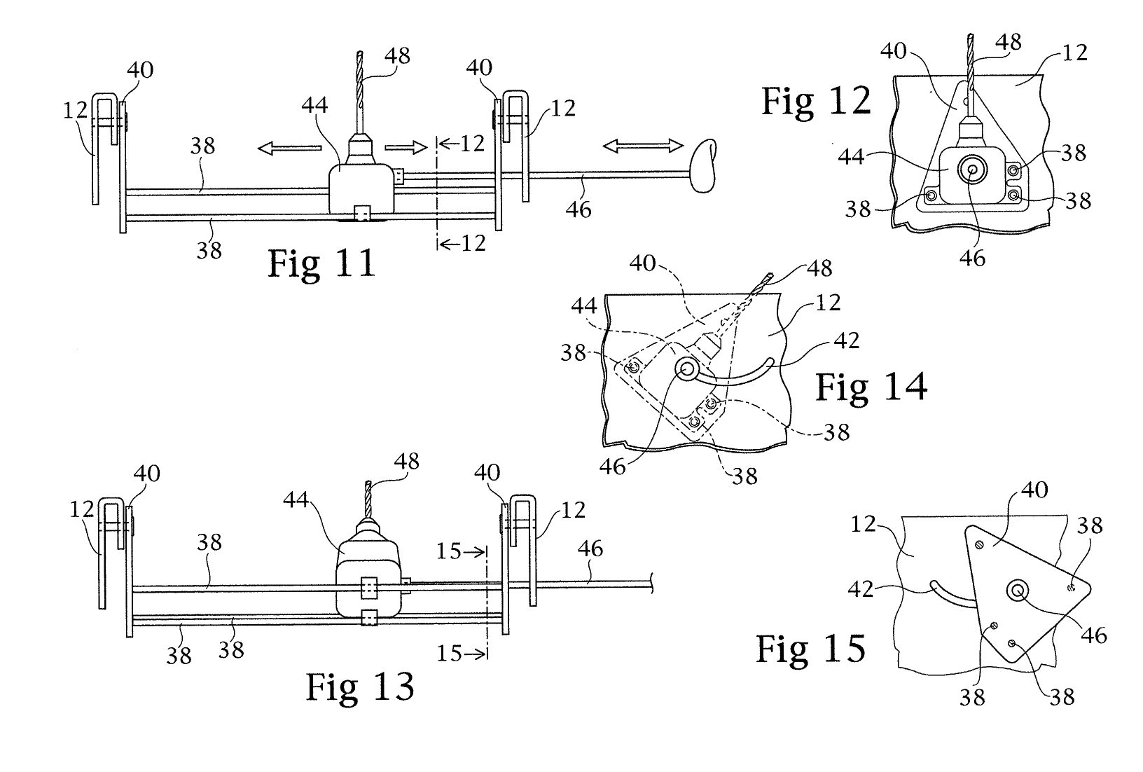

On the underside of the top surface 14 (FIG. 10), within the enclosure 14, are a plurality of spaced-apart support means 38. The support means 38 are under, and parallel with, the elongated opening 20. Preferably, the support means 38 are three rails each having a length greater than the length of the elongated opening 20. As shown in FIGS. 11-14, the opposite ends of each rail is mounted on a respective plate 40. Each plate 40 is pivotally connected to the housing 12. The plate 40 pivot locations are critically placed and identify the end point locations of the virtual transverse cutting axis XX.

An electrically-powered motor 44 is slidingly attached to the support means 38. A rod 46 is connected to the motor 44. The rod 46 has an end extending outwardly from the housing 12. Longitudinal movement of the rod 46 with respect to the elongated opening 20 in the top surface 14 produces concomitant sliding movement of the motor 44 along the support means 38.

A cutting means 48 is connected to the motor 44 such that powering of the motor drives the cutting means 48. The cutting means 48 is disposed in the elongated opening 20 in the top surface 14 of the housing 12 and projects upwardly above the horizontal plane of the top surface 14. In such a manner, the inside edge of the cutting means 48 follows precisely, the virtual transverse cutting axis XX. Thus, any workpiece W held in the workpiece holder 26 and extending over the elongated opening 20 may be contacted by the cutting means 48. The cutting means 48 may be a rotating cutting drill bit, a circular saw blade or any other cutting means known to persons skilled in the art. A cutting drill bit sold by Sears under the name “Saber-cut Zip Bits®” has been found to be useful.

The end of the rod 46 extending outwardly from the housing 12 serves as a handle. The rod 46 passes through an arcuate slot 42 formed in one of the side walls 16 of the housing 12. As the rod 46 is moved angularly with respect to a vertical plane through the elongated opening 20, the plates 40, the support means 38, the motor 44 and the cutting means 48 are all moved through the same selected angle. It is preferred that a scale ranging from −45° through 0° to +45° be formed on the one of the side walls 16 immediately adjacent to the arcuate slot 42. This provides a simple and accurate means to select an angle for bevel cutting the workpiece W. It is also preferred that an electrical switch be mounted on the handle of the rod 46 which is exterior to the housing 12. The electrical switch is electrically connected to the electric motor 44 and the motor 44 can be readily energized when positioned as desired.

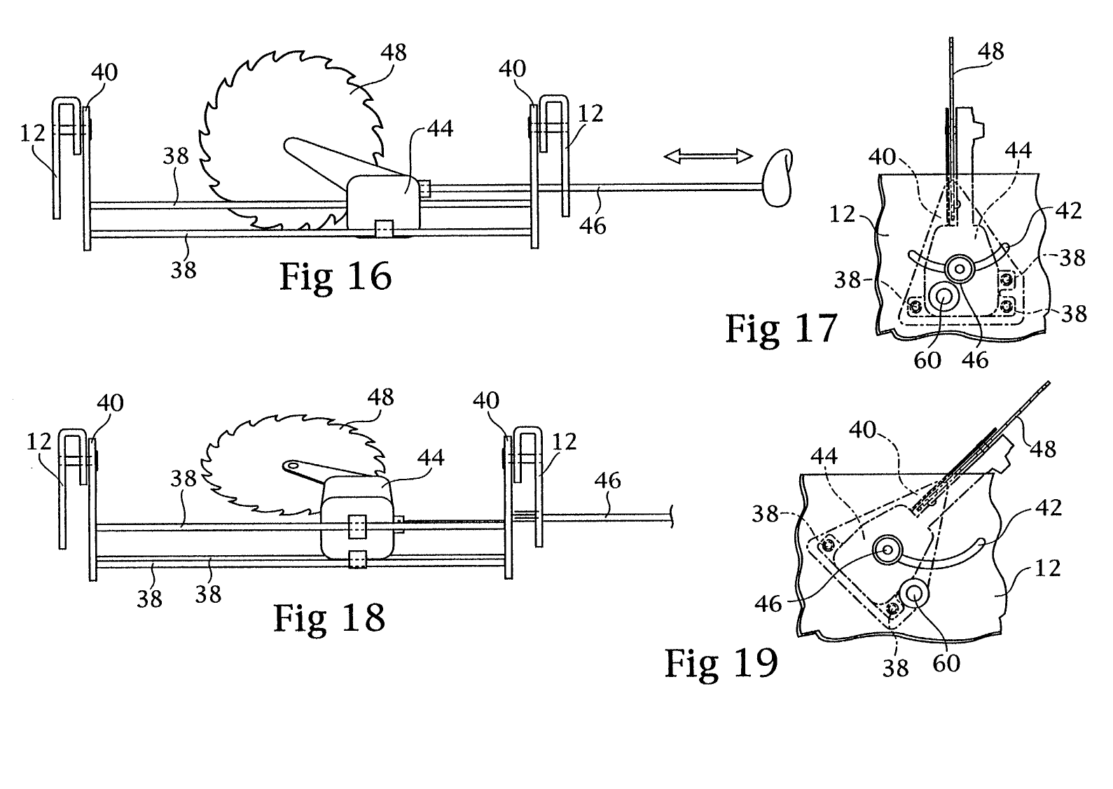

FIGS. 11-15 show a cutting drill bit as the cutting means 48 and FIGS. 16-19 show a circular saw blade on the cutting means 48.

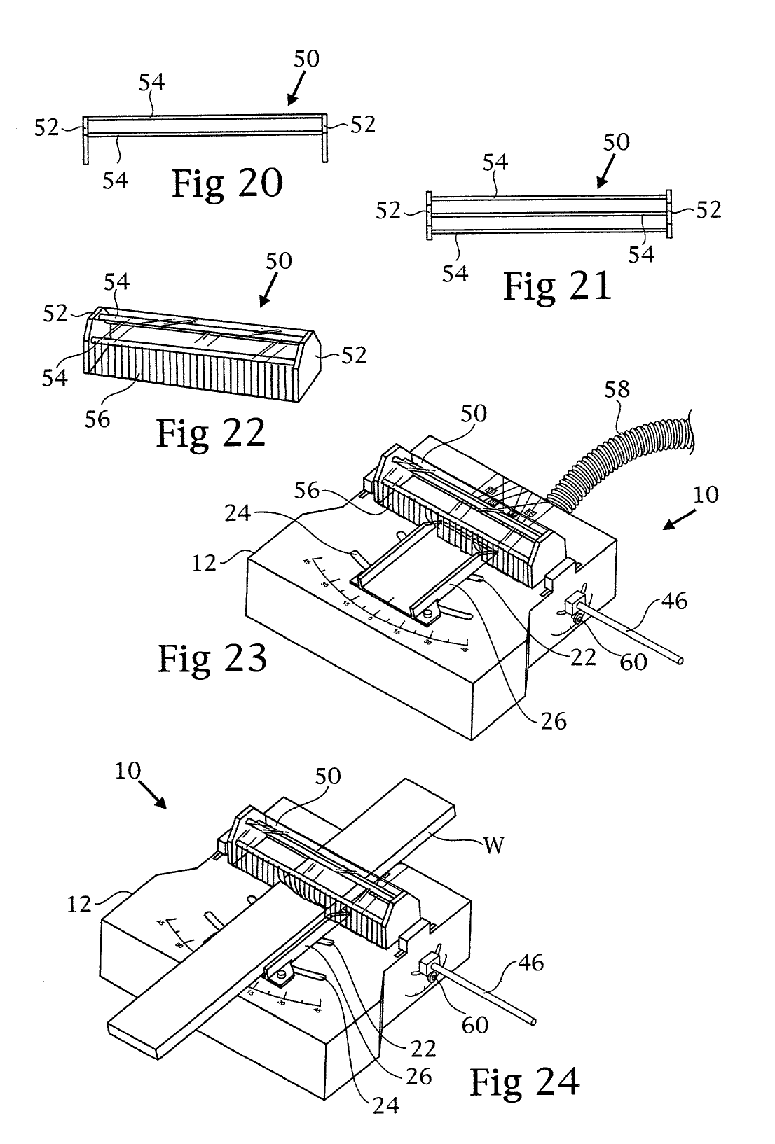

As shown in FIGS. 1, 20-22, a protector 50 is disposed on the top surface 14 of the housing over the elongated opening 20. Preferably, the protector 50 has a frame having two end pieces 52 and at least two shafts 54 therebetween. It is preferred that three shafts 54 be disposed between the end pieces 52. A cover 56 having at least a transparent portion is disposed over the frame. The transparent portion is at the top of the frame so that the cutting operation can be viewed by the operator. The protector also serves to prevent accidental contact with the cutting means 48. The protector may be removable and also may be pivotally mounted along one side so the protector 50 may be pivoted (or flipped) to permit access to the cutting means 48. In this situation, the protector 50 is interlocked to prevent operation of the cutting means 48 when the protector 50 is not in place over the elongated opening 20. The cover 56 extends downwardly over the frame as a curtain to direct debris and sawdust from the cutting operation downwardly through the elongated opening 20 and away from the operator. It is preferred that the downward extending curtain portion of the cover 56 be made of a type of flexible material allowing insertion of a workpiece but of such density to contain cutting debris. The workpiece W may be easily received under the fingers of the cover 56 and the fingers are effective in directing the debris and sawdust.

A source of vacuum 58 is optional and may be connected to the housing 12 to remove the debris and sawdust from the housing (FIG. 23). The source of vacuum may be connected to the housing 12 by a flexible hose inserted into a fitting or opening in the housing 12. Preferably the flexible hose is connected in the vicinity of the elongated opening 20 to more efficiently remove the debris and sawdust.

A typical miter box has dimensions of approximately 15″×10″×6″, however, the invention is not limited. Smaller miter boxes can be made for hobbyists and larger miter boxes could be made for professional use.

In use, an operator places the workpiece W in the work-holding member 26 with a portion of the workpiece W being disposed under the protector 50 and over the elongated opening 20. The work-holding member 26 is disposed at an angle to provide the selected angle at which the miter cut is desired. The angle can be set between −45° and +45° as indicated on the scale. Miter cuts between 45° and 90° can be made by turning over the workpiece W. For example, turning the workpiece W over and cutting in the opposite direction at 30° can produce a miter cut of 60°. The first end of the work-holding member 26 is aligned with the cut line through the elongated opening 20. The work-holding member 26 is locked in the selected angle by pins, screws, clamps, detent means or other means known to persons skilled in the art.

It is estimated that minimally skilled operators can obtain tolerances of less than 1/32″ for miter cuts, which is equivalent to the accuracy obtainable with table saws by nominally skilled operators.

The handle of the rod 46 to control the angular disposition of the motor 44 and cutting means 48 is moved to the selected angle. The handle is locked at the selected angle by pins, screws, clamps, detent means or other means 60 known to persons skilled in the art.

The motor 44 is energized by turning on an electrical switch which preferably is mounted on the handle to the rod 46. The switch may be a “trigger” switch which is conveniently held and activated by the operator. The switch is interlocked with the protector 50 and the motor 44 cannot be energized unless the protector 50 is disposed over the cutting means 48. The source of vacuum, if present, is activated. The operator firmly holds the workpiece W in the work-holding member 26, pressing the workpiece W against one of the side walls 30 of the work-holding member 26. The operator manually moves the handle to the rod 46 by either pushing the handle or pulling the handle so the cutting means 48 engages and cuts the workpiece W at the selected angle. An alternate embodiment has a drive motor connected to the rod 46 to provide for powered longitudinal movement of the rod 46, the motor 44 and the cutting means 48. A separate electrical switch connected to the drive motor is mounted on the miter box 10.

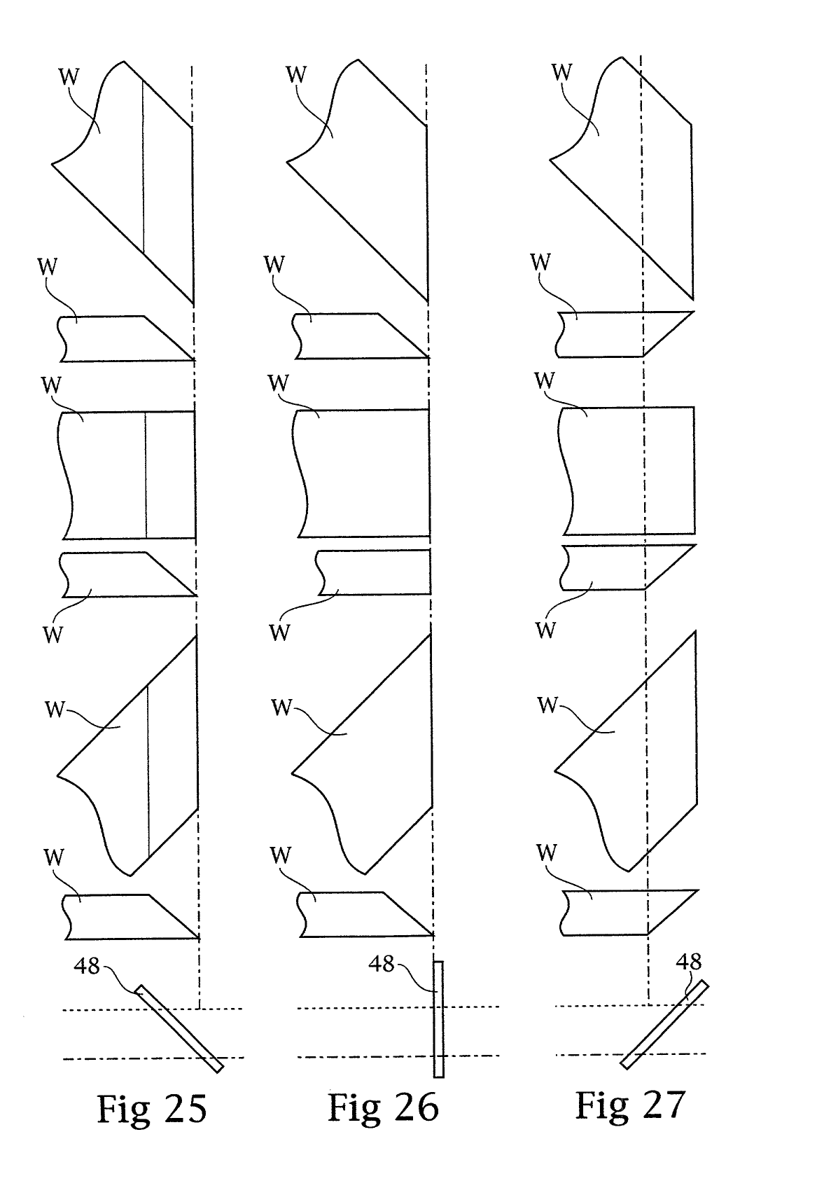

Referring to FIG. 25, with the cutting means 48 at a selected angle of −45°, three modes of disposition of the workpiece W are shown with the resultant cut of the workpiece W viewed from the top and the side of the workpiece W. As can be seen, the present invention provides for compound cutting of the workpiece W with a single action of the cutting means. Both miter cuts and bevel cuts can be made simultaneously. The cut line is shown as a vertical broken line with respect to a base line for the cutting means 48 and the angle of cut is relative to the edge of the workpiece being cut.

Referring to FIG. 26, the cutting means 48 is at an angle of 0° and the workpiece receives only a miter cut and not a bevel cut.

Referring to FIG. 27, the cutting means 48 is at an angle of +45° with respect to the base line of the cutting means. The cut line is shown as a broken vertical line perpendicular to the base line of the cutting means, and because of the negative angle of the cutting means, the bevel cut is away from the major portion of the workpiece. Both miter and bevel cuts are made simultaneously.

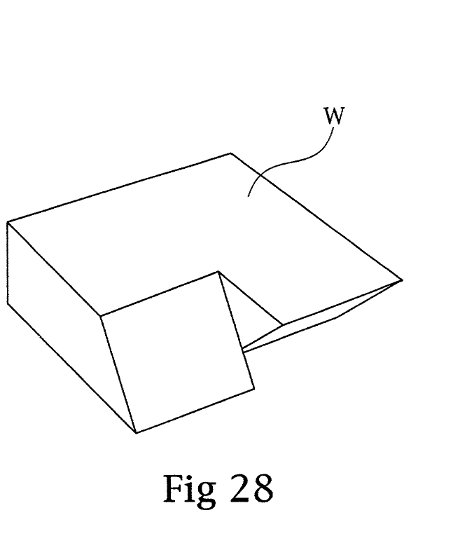

The miter box of the present invention is an extremely versatile, precision device. The support means 38 for the motor 44 allows the cutting means 48 to be drawn through the workpiece W in a straight, unwavering, and precise manner, ensuring the mitered crosscut to be made at the exact desired location. The swivel design of the support means 38 for the motor 44 provides a virtual axis to precisely set the bias of the mitered cut from +45° to −45° relative to the referenced cut line on the workpiece W being cut. The sliding movement of the work-holding member 26 on the top surface 14 of the housing 12 provides two virtual axes to precisely set the angle of the cut of the workpiece from +45° to −45° relative to either edge of the workpiece W. The virtual axis of the bias cut and the virtual axes of the angle cuts are independent of each other thereby allowing precise composite molding miter cuts over the entire adjustable ranges of the bias and angle cuts. The control configuration allows dynamic adjustment of the bias and angle cuts during the cutting process to produce complicated miter cut designs. Thus, as shown in FIG. 28, a bias cut on a single end of a workpiece can be made with a portion cut at 45° and an adjoining portion cut at an angle of −45° (or any combination of angles between +45° and −45°).

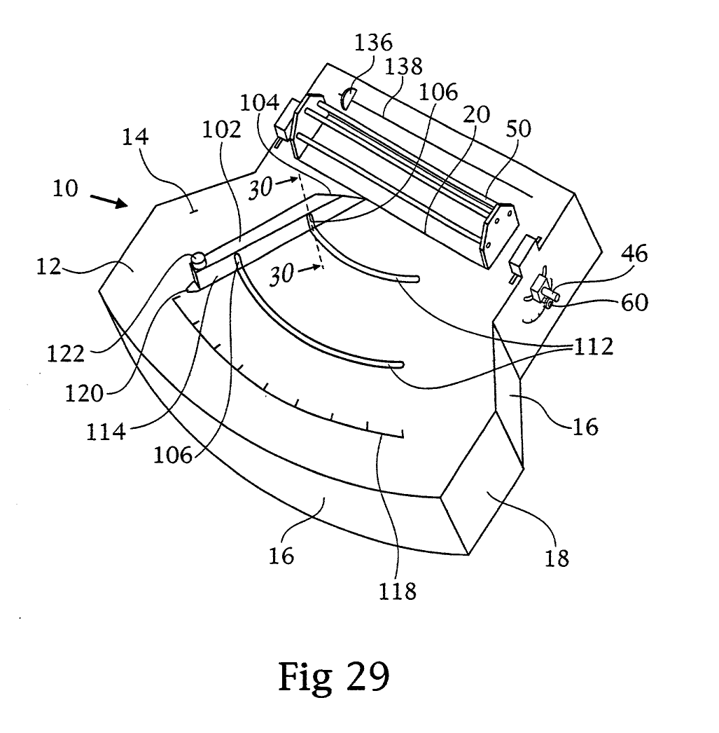

Alternately, as shown in FIG. 29 instead of the work-holding member 26, a fence or supporting member 102 is pivotally mounted on the top 14 of the housing 12. The fence 102 has a first end 104 which is pivoted at the intersection with the elongated opening 20 and preferably is displaced from the midpoint of the elongated opening 20. At least one and preferably two or more protrusions 106 extend downwardly from the fence 102. If there are two protrusions 106, they are spaced apart from one another. An upper portion of the protrusion 106 is received in a channel 110 formed in the fence 102 and the lower portion is received in a respective curved track 112 on the top 14 of the housing 12.

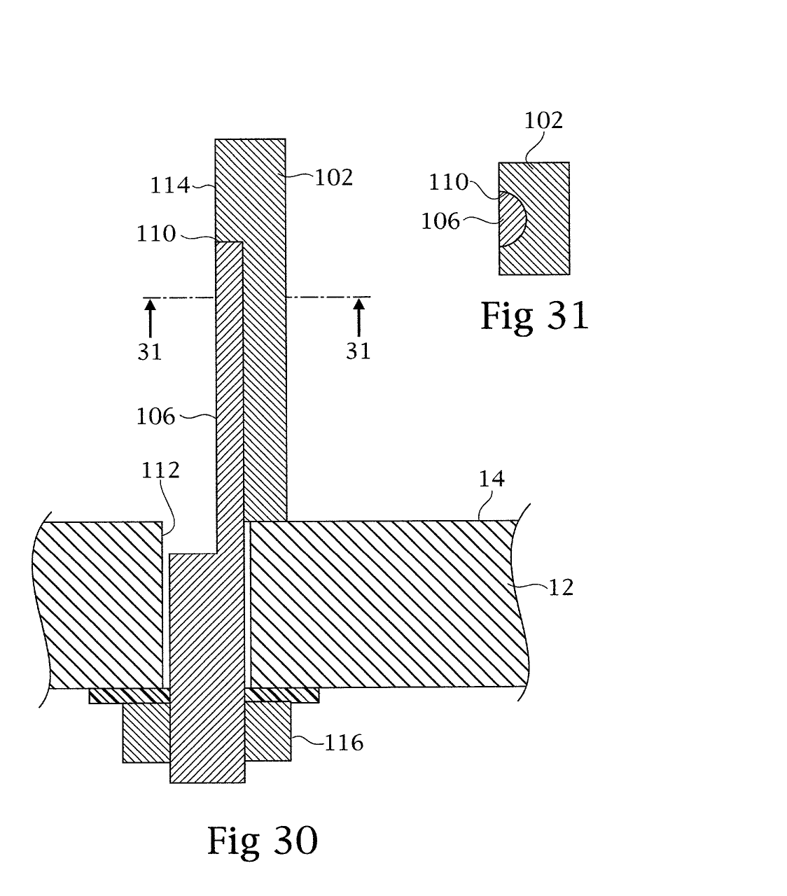

As shown in FIGS. 30-31, the channel 110 has a semicircular cross section and the upper portion of the protrusion 106 has a cooperating semicircular cross section. In this manner, the upper portion of the protrusion 106 is substantially flush with the working face 114 of the fence 102. The working face 114 is substantially perpendicular to the top 14 of the housing 12. The lower portion of the protrusion 106 is substantially circular in cross section and cooperates with the track 112. It is further preferred that a fastening means 116 be connected to the lowermost portion of the protrusion 106 to prevent the protrusion 106 and the fence 102 from being removed from the top surface 14 of the housing 12. The fastening means 116 preferably is formed from nylon or other material with a low coefficient of friction to provide ease of movement of the protrusion 106 in the track 112. If there are two or more protrusions 106, each is connected and mounted as described above in a respective channel and a respective track.

An angular scale 118 is formed on the top 14 of the housing in an arc distal from the first end 104 of the fence 102. The angular scale is marked at 0° on the midpoint and preferably extends ±45° on each side thereof so that movement through 90° can be indicated and selected. An index indicator 120 is formed on the second end of the fence 102 coplanar with the working face 102. The fence 102 may be pivotally moved in a horizontal plane over the top 14 of the housing 12 to align the index indicator 120 with a selected angle at which the miter cut is to be made.

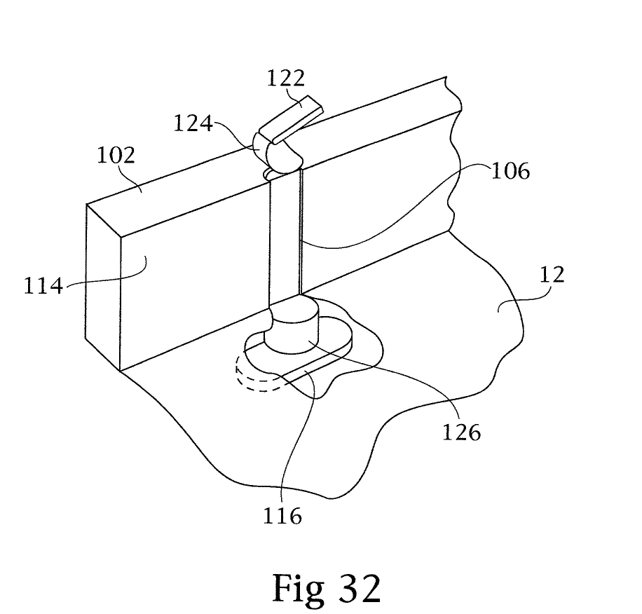

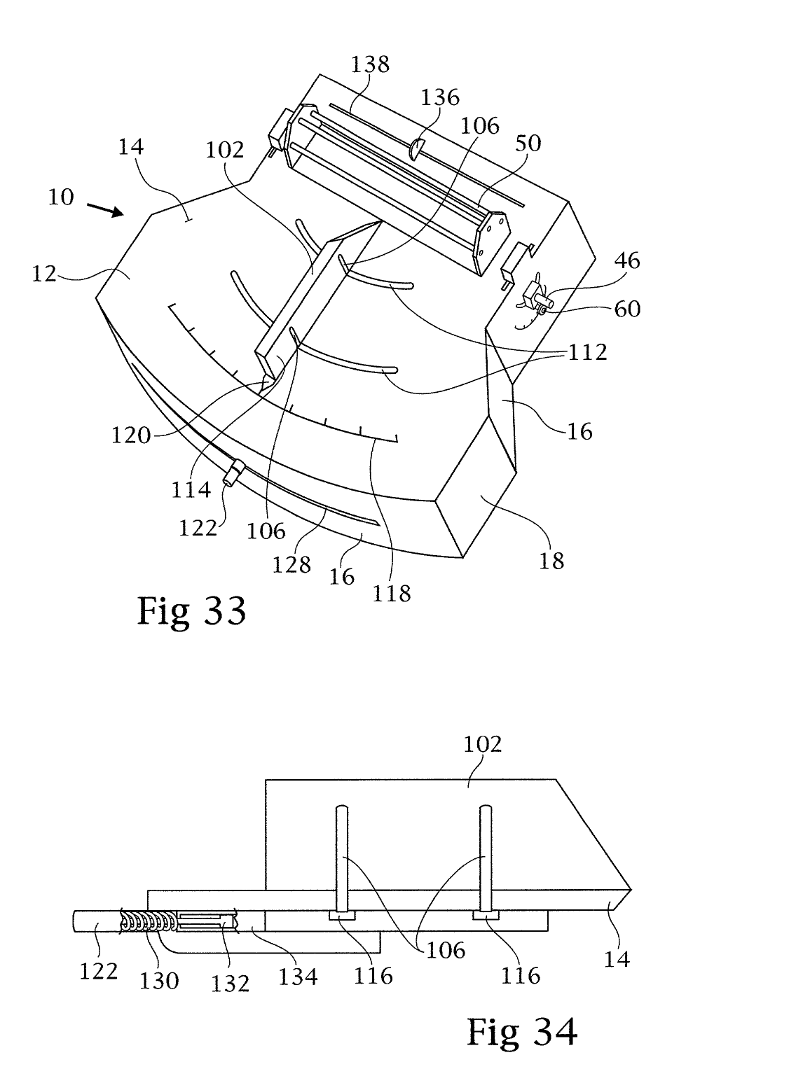

A handle 122 is connected to the fence 102 to pivotally move the fence. The handle 122 may be a simple knob attached to the fence 102 (FIG. 29) but preferably also incorporates a locking means to secure the fence 102 to the housing 12 when the fence 102 has been moved to the selected angle. The handle 122 and locking means may be of any type known to persons skilled in the art. An example is shown in FIG. 32 where the handle 122 is connected to the upper end of the protrusion 106. In this embodiment, the handle 122 has a cam surface 124 to bear against the upper end of the protrusion. A spring or resilient means 126 is disposed between the lower end of the protrusion and the fastening means 116 so that rotary movement of the cam surface 124 urges the fastening means 116 against the housing 12 and locks the fence 102 at the selected angle. Another embodiment is shown in FIGS. 33 and 34. The handle 122 is connected to the protrusions 106 which extend through the track 112 beneath the top 14 of the housing 12. The handle 122 extends outwardly from a slot 122 formed in the front wall of the housing 12 where it is accessible to the operator. Moving the handle 122 laterally in the slot 122 produces concomitant movement of the fence 102 to a desired angular position with respect to the virtual transverse cutting axis XX in the elongated opening 20. The handle 122 may be locked in the selected position by a spring 130 disposed in the handle 122 to urge a plunger 132 against a brake 134 or by a threaded nut on a cooperating threaded shaft. Other locking means known to persons skilled in the art may be used.

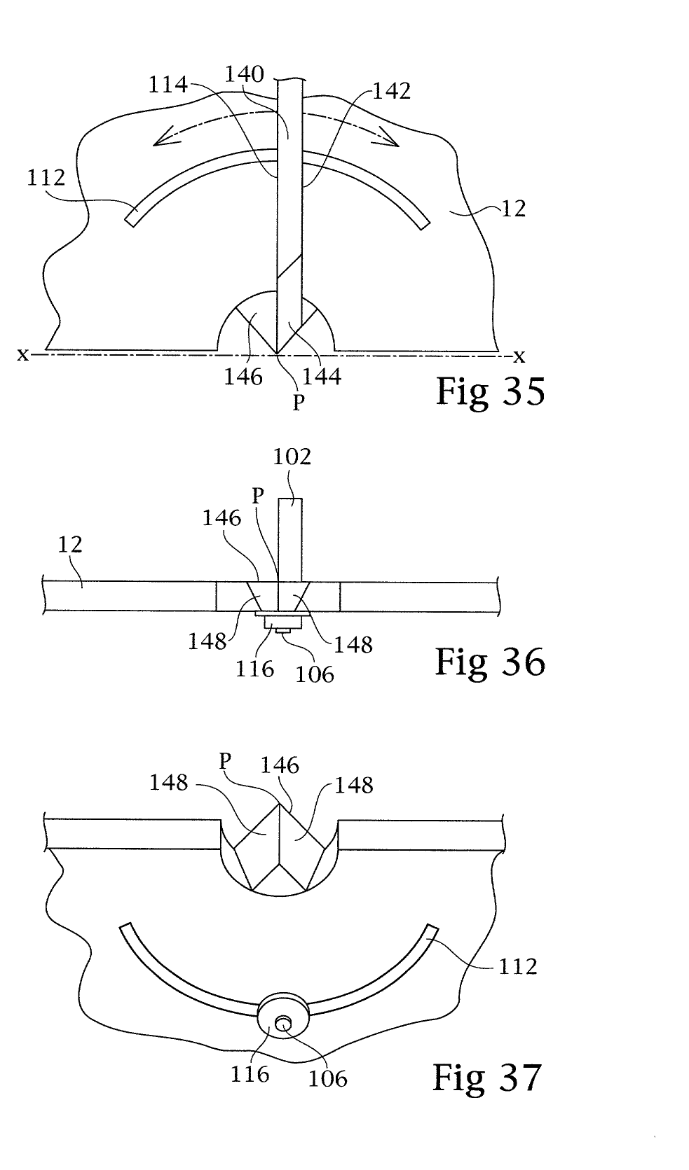

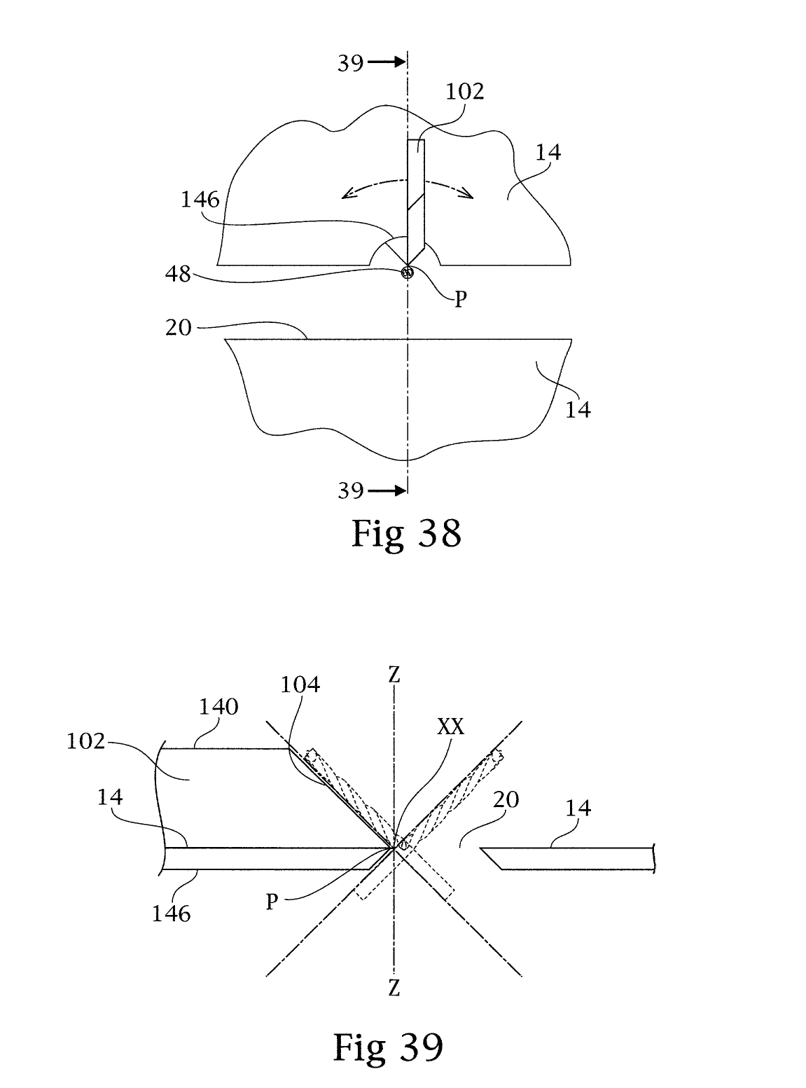

In order to assure that the workpiece W is cut at an angle corresponding with the angular setting of the fence 102, the protrusions 106 are flush with the working face 114 as previously described. Referring to FIGS. 35-40, the fence 102 has atop 140, a second face 142 opposite from the working face 114 and a first end 104. The first end 104 connects the working face 114 with the second face 142 and is formed at an angle of approximately 45° from the working face 114 to the second face 142. The first end 104 is also disposed at an angle from the pivot point to the top 140 of the fence 102. Preferably, the angle is approximately 45°.

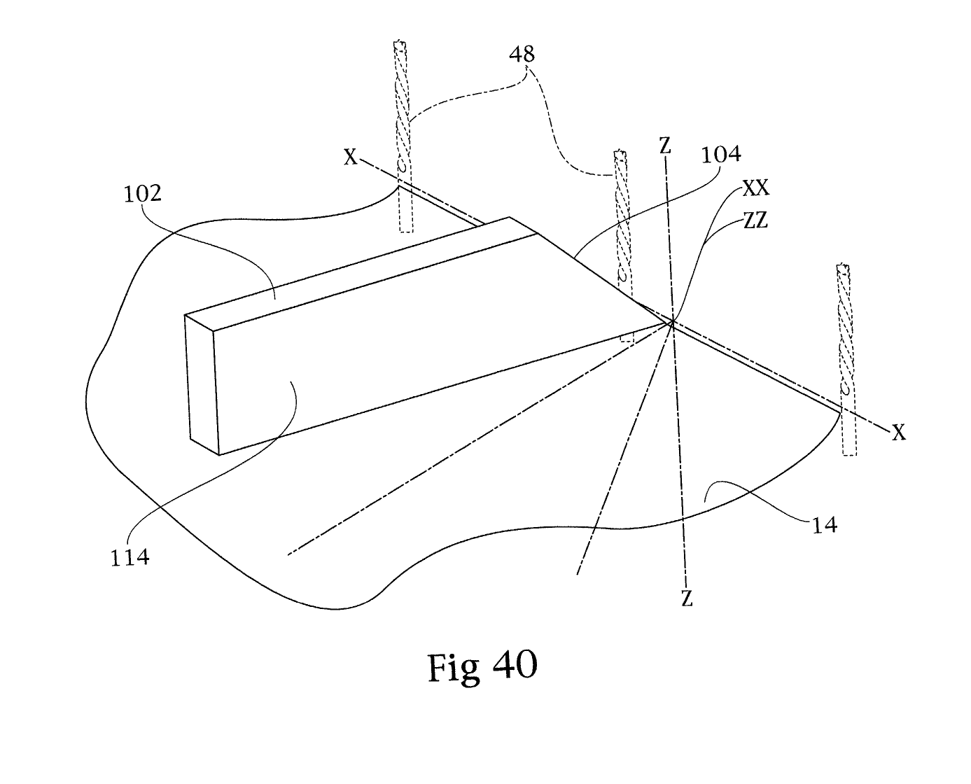

The fence 102 pivots The fence 102 pivots about a pivot point P at the intersection of the vertical axis ZZ and the virtual transverse cutting axis XX, as illustrated in FIG. 40. A small portion 146 of the top 14 of the housing 12 is separated from the major portion of the top and is connected to the first end 104 of the fence 102 and is pivotable around the pivot point P. The size of the small portion 146 may be the minimum area which can be attached to the fence 102 and provide bearing support to maintain the first end 104 of the fence 102 at the pivot point. The small portion 146 of the top 14 has two adjoining sides defining a 90° angle in a horizontal plane. The 45° angular first end 104 of the fence 102 abuts one of the sides of the small portion 146 and the working face 114 bisects the small portion 146 of the top 14. In this manner the pivot point coincides with the intersection of the vertical axis ZZ, spaced approximately 1/32″ from the intersection of the first end 104 of the fence 102, the small portion 146, and the virtual transverse cutting axis XX. The top 14 of the housing 12 has a thickness and, at the pivot point P, has two intersecting faces 148. Each face 148 extends downwardly from a respective side of the small portion 146 at a 45° angle with respect to the top 14 of the housing 12. Thus, as the cutting means 48 is slidingly moved at an angle of 45° or less to form a bevel cut on the workpiece W, the top 14 of the housing 12, the downwardly extending faces 148 and the fence 102 are clear of the cutting means 48 irrespective of the angular displacement of the fence 102 with respect to the elongated opening 20. The tolerances of the invention are designed so that the center line of the kerf of the cutting means is approximately 1/32 inch from the intersections of the three faces, 104, 146, and 148.

It is further preferred that at least one stop means 136 be disposed on a portion of the top 14 of the housing 12 across the elongated opening 20 opposite from the fence 102. The at least one stop means 136 is disposed in a channel 138 and may be moved to a desired position in the channel 138 and locked in the selected position. When the workpiece W is placed against the fence 102 with the workpiece W extending beyond the elongated opening 20, the stop means 136 is moved to contact the extended portion of the workpiece to provide additional support to the workpiece W as the cutting means 48 engages the workpiece.

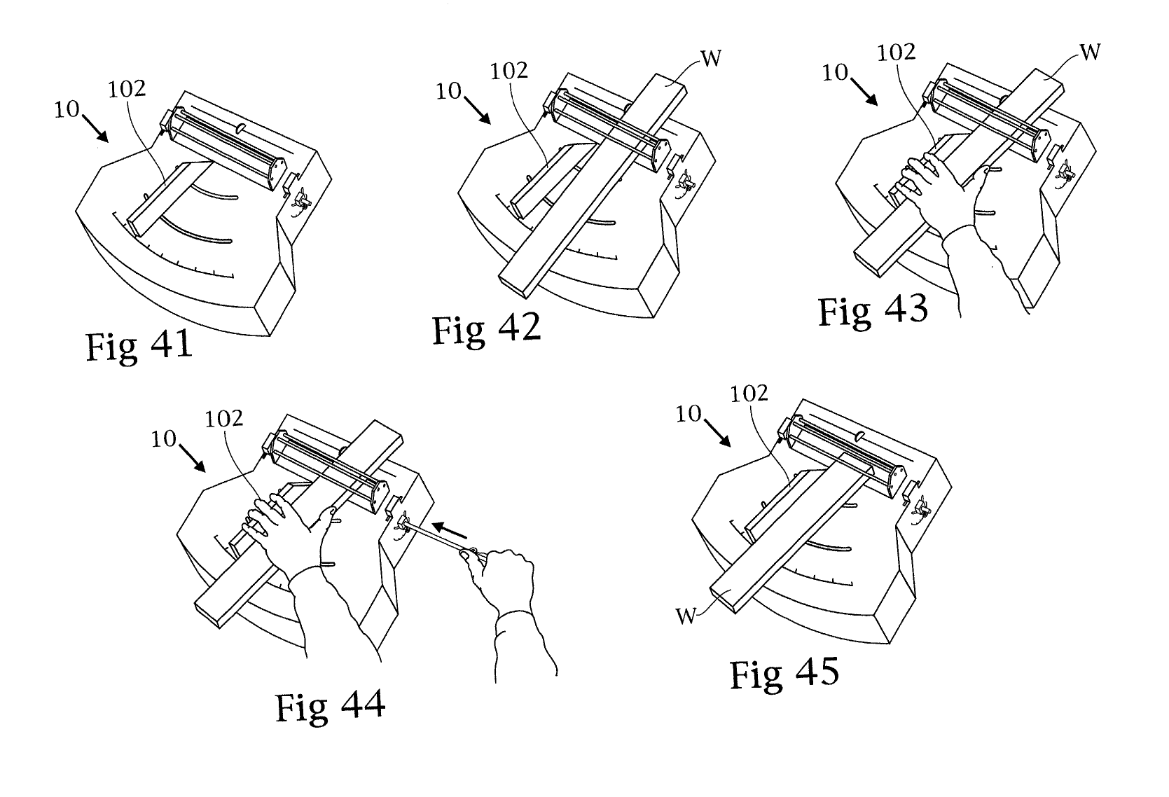

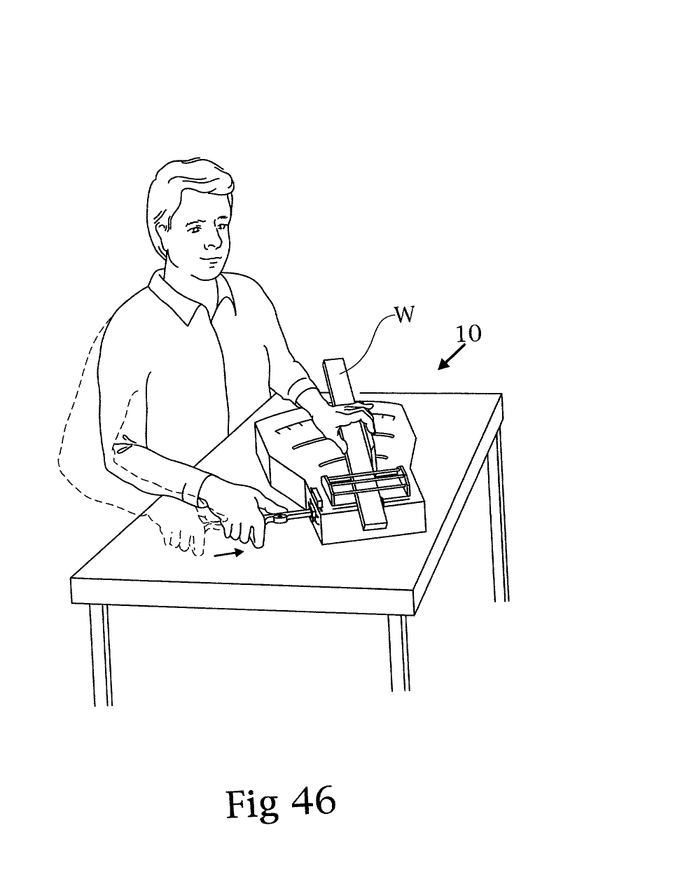

Thus in use (FIGS. 41-46), the fence 102 is pivoted to the desired angle with respect to the elongated opening 20 as shown on the angular scale 118 so that the desired miter cut may be provided. The workpiece W is disposed against the working face 114 of the fence 102. The stop means 136 is moved to abut the extending portion of the workpiece W on the side of the workpiece which is disposed against the working face 114 of the fence 102. The operator holds the workpiece firmly against the fence 102 and stop means 136 and energizes the motor 44 to the cutting means 48. While holding the workpiece, the cutting means 48 is moved to make the miter cut. Because of the index indicator 120 is coplanar with the working face 114 and the protrusions 106 are flush with the working face 114, the workpiece is miter cut at an angle exactly as indicated on the annular scale 118.

The present invention also provides the ability for the workpiece to be cut at a beveled angle either independently or in combination with the miter cut. As previously described, the cutting means 48 may be adjusted to a selected angular position with respect to a vertical plane through the housing. Thus, as the cutting means 48 is moved against the workpiece, depending upon the angular position of the cutting means 48 and the angle at which the workpiece is disposed with respect to the elongated opening 20, the workpiece is cut at a selected miter angle and also at a selected bevel angle.

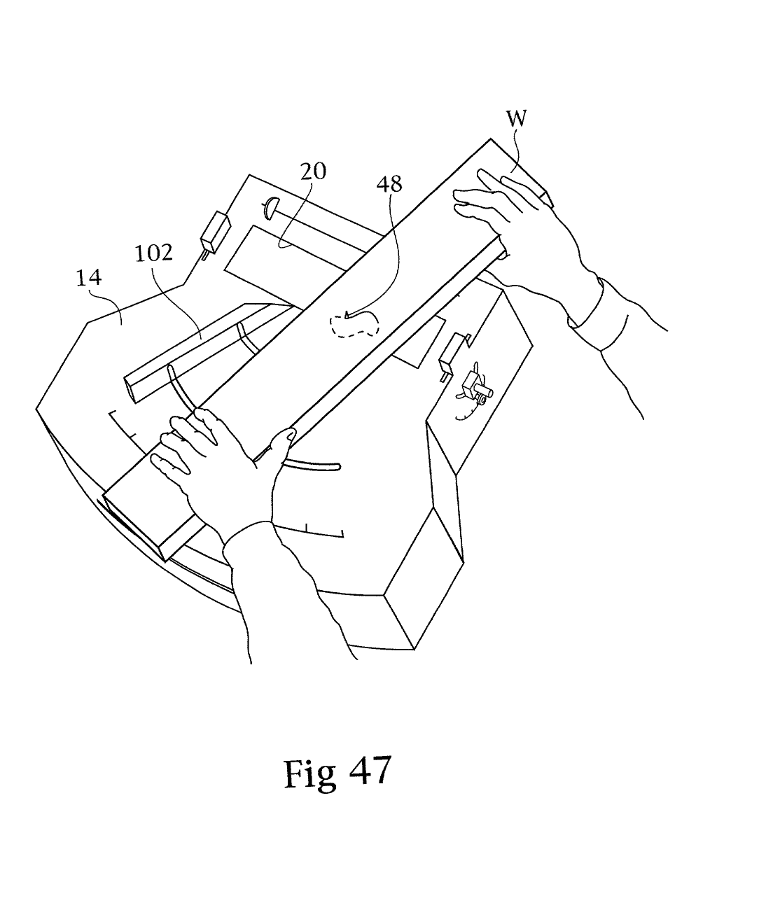

The present invention further has the versatility to be used as a scroll saw. As shown in FIG. 47, the fence 102 is pivoted to the extreme of the track 108 to provide maximum work space on the top 14 of the housing 12. The cutting drill bit 48 is slidingly moved to a selected position in the elongated opening 20 and locked in the position to prevent further sliding movement. A pattern to be cut out is marked on the surface of the workpiece and a pilot opening is cut in the pattern either by an independent method or by using the cutting drill bit 48. The workpiece W is disposed over the cutting drill bit 48 with the drill bit received in the pilot opening. If the pattern intercepts the end of the workpiece W or if the workpiece may be cut to reach the pattern, no pilot opening is required. The workpiece W is maneuvered around the cutting drill bit 48 to follow the pattern marked on the workpiece W and to cut out the pattern in the manner of a scroll saw. The cutting drill bit 48 may also be disposed at a selected angle with respect to the vertical plane through the housing 12. The angle may be through the range of +45° to −45° with respect to a vertical plane along the pivot axis of the cutting means. In this manner a bevel cut and scroll cut can be made simultaneously.

Obviously, many modifications may be made without departing from the basic spirit of the present invention. Accordingly, it will be appreciated by those skilled in the art that within the scope of the appended claims, the invention may be practiced other than has been specifically described herein.

What is claimed is:

1. A miter box comprising:
a housing having a top, an elongated opening formed in the top,
a cutting means slidably received within the housing, and disposed within the elongated opening,
at least one curved track formed on the top of the housing,
a fence pivotally mounted on the top of the housing, at least one protrusion extending downwardly from the fence, the at least one protrusion being received in the at least one curved track on the top of the housing,
the fence having a working face perpendicular to the top of the housing,
means for pivotally moving the fence, wherein the fence may be pivotally moved to a selected angle with respect to the elongated opening, a workpiece disposed against the working face of the fence, the workpiece extending over the elongated opening such that sliding the cutting means in the elongated opening cuts the workpiece at an angle corresponding to the selected angle at which the fence is disposed.

2. The miter box of claim 1, wherein the means for pivotally moving the fence is a handle connected to the fence.

3. The miter box of claim 1, further comprising means to lock the fence to the housing when the fence is moved to the selected angle.

4. The miter box of claim 1, further comprising an angular scale formed on the top of the housing such that the selected angle for moving the fence is clearly shown.

5. The miter box of claim 1, wherein the fence is pivotable through 90°.

6. The miter box of claim 1, further comprising at least one stop means disposed on a portion of the top of the housing across the elongated opening opposite from the fence wherein the workpiece extending over the elongated slot contacts the at least one stop means.

7. The miter box of claim 1, wherein the at least one protrusion is mounted flush with the work face of the fence.

8. The miter box of claim 1, wherein the cutting means is pivotably disposed with respect to a vertical plane through the housing and is arranged to a desired angular relationship relative to the vertical plane when a bevel cut of the workpiece is intended.

9. The miter box of claim 1, wherein the cutting means is connected to an electric motor, the electric motor having mounted on a rod extending outwardly from the housing wherein the rod may be slidably moved to move the cutting means.

10. The miter box of claim 9, wherein a trigger switch is mounted on an end of the rod externally of the housing, the trigger switch being electrically connected to the electric motor such that the cutting means may be activated as the rod is slidably moved.

11. The miter box of claim 1, wherein the fence pivots about a point at the intersection of working face of the fence with the elongated opening in the top of the housing.

12. The miter box of claim 11, wherein a portion of the top of the housing at the pivot point is pivotable and connected to the fence, the portion having two sides defining a 90° angle in the horizontal plane.

13. The miter box of claim 11, wherein the top of the housing at the pivot point has two intersecting faces extending downwardly, each face being at a respective 45° angle with respect to the top of the housing such that a bevel cut of the workpiece may be made.

14. The miter box of claim 1, wherein the fence has a top, a second face opposite from the working face, a first end of the fence connecting the second face with the working face, the first end of the fence being formed at approximately a 45° angle from the working face to the second face, the first end of the fence forming an angle from the pivot point to the top of the fence.

15. A miter box comprising:
a housing having a top, an elongated opening formed in the top,
a cutting means slidably received within the housing, and disposed within the elongated opening,
a fence pivotally mounted on the top of the housing,
the fence having a working face perpendicular to the top of the housing,
means for pivotally moving the fence, wherein the fence may be pivotally moved to a selected angle with respect to the elongated opening, a workpiece disposed against the working face of the fence, the workpiece extending over the elongated opening such that sliding the cutting means along a virtual transverse cutting axis in the elongated opening cuts the workpiece at an angle corresponding to the selected angle at which the fence is disposed.

16. In a mitering machine, the combination of a table having an arcuate slot formed therein; a pivotable fence on top of the table and having a working face against which a workpiece is positioned; the pivotable fence further having a protrusion depending therefrom, received within the arcuate slot in the table, and extending therebelow; the protrusion comprising a rod having a half-round portion received within a complementary recess formed in the side face of the pivotable fence, such that the half-round portion of the rod is flush with the working face of the pivotable fence against which the workpiece is positioned; the pivotable fence having a pivot axis which is at the center of the arcuate slot in the table; the working face of the pivotable fence extending within a plane that encompasses the pivot axis of the pivotable fence; and the pivotable fence being locked in a desired position prior to making a miter cut on the workpiece.

17. A miter box for a workpiece having a housing having a top and an elongated opening formed in the top, comprising:
a cutting means slidably received in the housing and extending upwardly of the top, the cuffing means being pivotally disposed with respect to a vertical plane when a bevel cut of the workpiece is intended,
a fence mounted on the top of the housing at a pivot point, the pivot point being on a vertical axis at the intersection with the elongated opening wherein the fence may be pivotally moved to a selected angle with respect to the elongated opening,
a portion of the top of the housing at the pivot point being connected to the fence and being pivotable, the portion having two sides defining a 90° angle in a horizontal plane,
the portion of the top of the housing at the pivot point having two intersecting faces extending downwardly, each face being at a respective 45° angle with respect to the top of the housing such that the bevel cut of the workpiece may be made by slidingly moving the cutting means in the elongated opening, the cutting means further cutting the workpiece at an angle corresponding to the selected angle at which the fence is disposed.

18. The miter box of claim 17, wherein the fence has a top, a first face against which the workpiece is supported, and opposite second face, and a first end connecting the first face to the second face, the first end being formed at approximately a 45° angle between the first face and the second face, the first end extending from the pivot point angularly to the top of the fence.

19. A cutting device for a workpiece comprising a housing having a top, an elongated opening being formed in the top,
a rotating cutting bit slidably received in the opening and extending upwardly of the top of the housing,
a fence mounted on the top of the housing at a pivot point, the pivot point being on a vertical axis at the elongated opening wherein the fence is pivotally movable to a selected angle with respect to the elongated opening,
wherein the workpiece is supported against the fence and the cutting bit is slidingly moved to miter cut the workpiece at an angle corresponding to the selected angle at which the fence is disposed,
and further wherein when the cutting bit is locked in a selected position, the workpiece is disposed over the cutting bit and maneuvered around the cutting bit to provide a scroll cut to the workpiece,
such that the cutting device is versatile being used for miter cuts, bevel cuts and scroll cuts.
